(19) United States
(12) Patent Application Publication
(10) Pub. No.: US 2006/0024839 A1
(43) Pub. Date: Feb. 2, 2006

(54) Inorganic carbon removal

(76) Inventors: Viatcheslav A. Petropavlovskikh, LOUISVILLE, CO (US); Richard D. Godec, Longmont, CO (US)

Correspondence Address: David Silverstein;Andover-IP-Law, Suite 300, 44 Park Street, Andover, MA, 01810, US

(21) Appl. No.: 10/523,185

(22) PCT Filed: Aug. 7, 2003
(86) PCT No.: PCT/US03/24970

§ 371 Date: Jan. 28, 2005

Related U.S. Application Data
(60) Provisional application No. 60/402,222, filed on Aug. 9, 2002.

(51) Int. Cl. B01L 11/00

(52) U.S. Cl. 436/178; 422/101

(57) ABSTRACT

Methods and related apparatus are disclosed for selective removal of inorganic carbon from a fluid sample using selective membranes to minimize the loss of volatile organic compounds from the fluid sample prior to analysis for determination of the total organic carbon contents of the sample.

### FIELD OF THE INVENTION

This invention relates particularly to methods and apparatus for facilitating the selective and sensitive detection of organic carbon compounds in water by first treating an aqueous solution for the selective removal of inorganic carbon (IC), which may be in the form of CO₂, HCO₃—, and/or CO₃⁻², using a gas-permeable membrane having a relatively high permeability to carbon dioxide and a relatively low permeability to volatile organic compounds. More generally, the methods of this invention can be applied to separating IC from a fluid stream, which can be a gas or liquid stream, without substantially removing or affecting volatile organic components of that gas or liquid stream.

### BACKGROUND OF THE INVENTION

In recent years it has become increasingly important to be able to accurately and reproducibly determine to very low levels, on the order of a few parts per billion, the organic carbon content of an aqueous sample. Sensitive industrial applications, for example, semiconductor manufacture, require extremely pure water that is substantially free of organic carbon contamination. Another example is municipal drinking water systems where the presence of even very small amounts of organic carbon contaminants could, during conventional chlorination treatments, produce deleterious chlorinated hydrocarbons.

Because carbon may be present in an aqueous sample either in an organic form or in an inorganic form (for example, as dissolved carbon dioxide or in ionic form as carbonate or bicarbonate), the prior art has long recognized the need for distinguishing these two forms of carbon in order to obtain accurate determinations of organic carbon. In general, two approaches have been developed for addressing this problem.

Thus, conventional TOC (total organic carbon) analyzers either measure separately the concentrations of IC (inorganic carbon) and TC (total carbon) in the sample to obtain mathematically a measure of TOC; or, alternatively, the IC is removed from the sample prior to analysis for TOC. In the first case, the IC concentration is subtracted from the TC concentration to calculate the TOC concentration. However, the precision of this technique is low when the IC concentration is relatively large in comparison to the TOC concentration because even small percentage inaccuracies in the IC and TC determinations significantly impact the TOC calculation.

For samples having a relatively high ratio of IC/TOC, better precision is obtained when the second approach is adopted. By substantially removing the IC from the sample before making a TC determination, TOC is determined directly thereby avoiding the need to calculate the TOC concentration from the difference between two larger values (TC and IC). Additionally, the time required for the measurement often is less when IC is removed first than when both IC and TC have to be separately measured.

A number of prior art patents and literature references teach various approaches to addressing IC in a process for measuring TOC. Of these, some teach selective removal of IC from an aqueous sample prior to making a TC determination and others do not. For example, U.S. Pat. No. 4,209,299, “Method and Apparatus for Determination of Volatile Electrolytes,” (Robert M. Carlson) has no reference to selective removal of IC in the determination of volatile organic compounds. U.S. Pat. No. 5,567,388, “Apparatus for Measuring Total Organic Carbon,” (Morita et al.) describes use of a sample solution, to which base has been added, as removal/acceptor media specifically for carbon dioxide. This patent does not, however, teach use of a selective membrane to prevent removal of volatile organic compounds. U.S. Pat. No. 5,051,114, “Perfluorodioxole membranes,” (Nemser et al.) describes enrichment and removal of volatile components selectively in a gas/gas configuration. U.S. Pat. No. 6,248,157, “vacuum degassing,” (Sims et al.) describes vacuum degassing without selective removal of IC relative to volatile organics. U.S. Pat. No. 5,443,991, “Method for determination of dissolved carbon in water,” (Godec et al.) describes the use of a CO₂-permeable membrane, but does not address the problem of possible loss of volatile organic compounds. The foregoing U.S. patents are incorporated herein by reference.

In addition to the foregoing patents, other patents and technical literature address various aspects of this technical field. One well-established method of removing IC from an aqueous sample before making a TC determination involves acidification of the sample to a pH of about 2 or less to convert all HCO₃⁻ and CO₃⁻² to carbon dioxide, followed by purging the sample with a gas stream for several minutes to remove the CO₂. Many publications and patents have described methods and instrumentation that incorporate acidification and gas purging for IC removal. Such prior art includes Kaplan, L. A., “Comparison of Three TOC Methodologies,” J. AWWA, Vol. 92, Issue 4, pp. 149-156; April, 2000; Takahashi, Y., “Sparging Device,” U.S. Pat. No. 3,958,945 (Envirotech Corporation) May 25, 1976; and, Purcell, M. W.; Yang, S. S.; Martin, J. T.; Reckner, R. R. and Harris, J. L., “Liquid Sample Carbon Analyzer,” U.S. Pat. No. 6,007,777 (Tekmar Company) Dec. 28, 1999, each of which is incorporated herein by reference. A disadvantage of this procedure is that at least some indeterminate portion of volatile organic compounds originally present in the sample is likely to be lost from the sample during the gas purging step leading to inaccurate TOC measurement (see, e.g., American Water Works Association, “Total Organic Carbon (TOC),” Standard Method 5310C in Standard Methods for the Examination of Water and Wastewater, 19th Edition Supplement; 1996). The fraction of such volatile, purgeable organic compounds in a sample is commonly referred to as “Purgeable Organic Carbon” (POC); while the fraction of organic compounds that is not lost during purging is referred to as “Non-purgeable Organic Carbon” (NPOC). For some samples, gas purging may be acceptable and not a significant source of inaccuracy because the POC content of such a sample represents only a small proportion of the overall TOC content.

However, many types of aqueous samples which are of particular interest in many modern, ultra high purity industrial and other applications have substantial concentrations of POC, (see, e.g., Barcelona, M. J, “TOC Determinations in Ground Water,” Ground Water, Vol. 22(1), pp. 18-24; 1984). For these samples, gas purging is not an acceptable choice for IC removal. For such samples, alternative membrane-based techniques have been developed. In one early such membrane-based process, the sample is acidified to convert IC to carbon dioxide. This acidified solution is then flowed on one side of a nonporous, gas-permeable silicon rubber membrane, allowing the carbon dioxide to diffuse through the membrane. A basic solution on the other side of the membrane absorbs the carbon dioxide because the base converts the carbon dioxide to bicarbonate and carbonate ions. Such a process is taught by West, S. J.; Frant, M. S. and Ross, J. W., Jr., “Development of a Water Quality Monitor for Spacecraft Application,” SAE Paper 76-ENAs-10, Presented at International Conference on Environmental Systems, San Diego, Calif.; Jul. 12-15, 1976.

This process was refined in subsequent developments, one of which involved splitting the sample into two parts, with one being acidified while the other is made basic. These two portions of the sample are then flowed on opposite sides of the same gas-permeable membrane, such that the IC from the acidified portion diffuses through the membrane into the basic portion. See e.g., West, S. J.; Frant M. S. and Franks S. H., “Preliminary Design of a Preprototype Water Quality Monitor,” SAE Paper 77-ENAs-36, Presented at International Conference on Environmental Systems, San Francisco, Calif., Jul. 11-14, 1977. See also, Lantz, J. B.; Davenport, R. J.; Wynveen, R. A. and Cooper, W. J., “Development of TOC/COD Analyzer for Process Applications,” Chemistry in Water Reuse, Volume 1, Cooper, W. J. (Ed.), Ann Arbor Science Publishers, Inc.; 1981. One advantage of this arrangement is that volatile organics in the acidified sample are not lost through the membrane because the partial pressure of those organics remains virtually the same on both sides of the membrane. A disadvantage is that both acid and base reagents are required.

Silicon rubber is deteriorated by prolonged contact with strong acids and bases, however, so more durable and inert membrane materials were needed. Microporous Teflon) has been found useful in this application. See e.g., West, S.; Chrisos, J. and Baxter, W., “Water Quality Monitor,” Final Report, NASA Contract NAS9-14229; Orion Research, Inc., Cambridge, Mass.; March 1979. U.S. Pat. No. 5,567,388 (Morita et al.) teaches that films of polytetrafluoroethylene, silicone rubber, cellulose acetate, or porous polyethylene, or a composite film made from those materials, can be used to remove IC from an acidified sample stream, with the carbon dioxide diffusing into a portion of the sample on the other side of the membrane that has been made basic.

There are still several problems and limitations, however, with this approach. One problem is that strong acids and bases, as well as some water sample constituents, attack non-porous membranes made from many traditional materials. Silicon rubber and cellulose acetate are among this group.

Non-porous polytetrafluoroethylene and polyethylene are typically compatible with strong acids, strong bases, and typical water sample constituents, but the rates at which carbon dioxide diffuses through these membranes are so low that an IC removal device based on such membranes would have to be very large to process a typical sample in a reasonable time. A large IC removal device, however, causes slow response of the TOC analyzer when a new sample is measured after measuring another sample that has a significantly different concentration. It has also been found that there can be problems with conventional porous membranes. One problem is that constituents of some water samples wet the surfaces of these porous membranes, thereby allowing the solutions on either side of a membrane to mix. This causes measurement errors and increases maintenance labor associated with the apparatus. Another problem is that conventional porous membranes allow volatile organics to rapidly diffuse from the acidified sample stream into the basic solution. To avoid such loss of volatile organics, thereby distorting the accuracy of a TOC measurement it is necessary to use two portions of the sample (one acidified and one made basic) on each side of a porous membrane, as discussed above. When this is done, however, the apparatus is more complex and costly, and an additional reagent is required to make the sample basic.

These and other problems with and limitations of the prior art methods are overcome in whole or in part with the methods and apparatus of the present invention.

### OBJECTS OF THE INVENTION

Accordingly, a general object of the present invention is to provide improved methods and related apparatus for processing a sample fluid for the selective removal of inorganic carbon, as defined herein, while minimizing the removal or loss of volatile organic compounds.

Another general object of the present invention is to provide a system, and methods of using such system, for passing a fluid sample along one side of a selectively gas-permeable membrane while passing an acceptor medium along the opposite side of the same membrane in order to selectively diffuse at least one component of the fluid sample through the membrane and into the acceptor medium without significantly altering the content of at least one other component of the fluid sample.

It is a principal object of this invention to provide methods and apparatus for more efficient, simple, compact and accurate determinations of the total organic carbon content of a fluid sample by selective removal of inorganic carbon from the sample before analysis.

A specific object of the present invention is to provide gas permeable membranes having a relatively high permeability to carbon dioxide and a relatively low permeability to volatile organic compounds as part of a system for the selective removal of inorganic carbon from a fluid sample prior to analysis without significant loss of volatile organic compounds together with methods for operating such a system.

Another specific object of this invention is to provide a system and methods for acidifying or not acidifying an aqueous sample and thereafter passing it into contact with one face of a CO₂-selective membrane, while contacting the opposite face of the membrane with a substantially CO₂-free acceptor medium, to remove inorganic carbon from the sample to prepare the sample for analysis for total organic carbon content.

Still a further specific object of this invention is to use membranes made of Teflon AF, PFA, Polyfluoropolymer and comparable materials as CO₂-selective membranes in methods and apparatus for selective removal of inorganic carbon from a fluid sample stream without significantly removing volatile organic compounds.

Other objects and advantages of the present invention will in part be obvious and will in part appear hereinafter. The invention accordingly comprises, but is not limited to, the methods and related apparatus, involving the several steps and the various components, and the relation and order of one or more such steps and components with respect to each of the others, as exemplified by the following description and the accompanying drawings. Various modifications of and variations on the method and apparatus as herein described will be apparent to those skilled in the art and all such modifications and variations are considered within the scope of the invention.

### SUMMARY OF THE INVENTION

In a first embodiment, the present invention comprises methods and related apparatus for facilitating the selective and sensitive detection of organic carbon compounds in a fluid by selective removal of inorganic carbon (IC) from the fluid using a gas-permeable membrane having a relatively high permeability to carbon dioxide and a relatively low permeability to volatile organic compounds. The present invention provides an easy and reliable way to remove IC from a sample gas or liquid stream without significantly impacting the accuracy of a subsequent analytical measurement for organic carbon. More specifically, this invention is useful in removing IC from a water sample without significantly changing the TOC content of that water sample.

In another embodiment, this invention comprises methods and related apparatus for selective removal of Inorganic Carbon (IC defined as the sum of the concentrations of CO₂, HCO₃⁻, and CO₃⁻²) from liquid analyte with minimal removal of volatile organic compounds.

In still another embodiment, this invention relates to improving TOC measurements by the selective removal of substantially all or at least excess IC from a donor sample stream, to an acceptor stream, with minimal removal of volatile TOC from the donor sample stream. This invention therefore overcomes a problem with existing non-selective degassing and purging techniques in that they typically remove significant amounts of volatile organic compounds from samples that are intended to be subsequently analyzed for TOC.

The Total Carbon (TC) content in water consists of two components, TOC and IC. TC and IC each can be measured, and TOC then can be calculated from the equation: TOC=TC−IC. However, when the concentration of TOC is significantly less than the IC concentration, it is essentially impossible to precisely determine the TOC concentration from the small difference between the large TC and IC concentrations. The precision of the TC and IC measurements is adversely affected by the normal “noise” associated with any analytical measurement and such effect may be substantial in relation to a relatively small, but still significant, TOC content.

Thus, when the IC concentration is larger than the TOC concentration, the TOC measurement will be more precise if the IC is removed prior to the carbon measurement. When that is done, the TOC concentration becomes substantially if not exactly equal to the measured total carbon concentration TC. In the prior art, IC removal employs non-selective degassing of the acidified sample or so-called acid sparging treatment. Both methods involve acidification of the sample with an inorganic acid. Then, the sample is either degassed (with or without membrane separation), or it undergoes a sparging. The fist technique requires a vacuum pump and usually, a carbon dioxide scrubber to purify any gas that flows over the acidified sample. The second technique requires a supply of carbon dioxide-free gas. The efficiency, quality and purity of these consumables can often vary in ways that affect the efficiency of the IC removal process and/or the accuracy of subsequent TC measurement

In contrast with the prior art, the methods and apparatus of this invention are based on the use of a non-porous gas- permeable membrane that has a relatively high permeability for carbon dioxide and a relatively low permeability for volatile organic compounds. The membrane separates the fluid analyte (which may also be called the donor stream) from a second fluid stream (which may also be called the acceptor stream), which initially contains essentially no IC. Carbon dioxide diffuses from the fluid analyte (which may in some embodiments be acidified to assist in converting carbonate and bicarbonate ions to carbon dioxide), through the membrane and into the acceptor stream. The carbon dioxide and bicarbonate ions which diffuse into the acceptor stream as a result of carrying out this method may be subsequently removed by externally provided carbon dioxide-free gas or with ion-exchange resin. These methods and related apparatus of this invention are ideal for removal of background IC from a water sample before Total Carbon (TC) is measured. With the prior removal of IC, TOC will be the same as the measured TC.

### BRIEF DESCRIPTION OF THE DRAWINGS

FIG. 1 is a schematic flow diagram of one embodiment of the present invention utilizing a planar membrane element.

FIG. 2 is a schematic flow diagram of another embodiment of the present invention utilizing a tubular membrane element.

FIG. 3 is a graph of IC removal efficiency plotted against residence time for three types of acceptor media in accordance with the present invention.

FIG. 4 is a graph of IC removal efficiency plotted against residence time at three temperatures.

FIG. 5 is a graph of IC removal efficiency plotted against residence time at three concentrations of inorganic carbon.

FIG. 6 is a graph of before and after concentrations of various volatile organic compounds in a fluid sample showing, for each of two types of membrane material, the extent to which IC removal practiced in accordance with the present invention impacts the level of the volatile organic compound in the sample.

### DETAILED DESCRIPTION OF PREFERRED EMBODIMENTS

The present invention is generally directed to the use of particular types of membrane materials in connection with methods and apparatus for selective removal of inorganic carbon (IC), defined herein as the sum of the concentrations of CO₂, HCO₃⁻ and CO₃⁻², from a fluid medium with little or no removal of volatile organic compounds so as not to adversely affect a subsequent analysis of the fluid medium for determination of total organic carbon (TOC).

In accordance with this invention, two ways have been found to achieve selective removal of IC from a fluid medium. The first is based on the choice of the membrane material. Although porous materials provide very high permeation rates for gases, they do not provide any selectivity. Non-porous membranes, on the other hand, if properly selected, provide an opportunity to achieve selectivity because of differences in the permeability rates of different compounds through the membrane material. We have now found that at least relative to IC and TOC, it is possible to choose a membrane material with a higher rate of permeation for the compound of interest compared to other compounds in the analyte. In addition, optimization of residence time and temperature of the analyte can further enhance the selectivity of this separation step.

A second way to provide or enhance selectivity is to change the pH. Thus, the fluid analyte stream (donor side) can be acidified to push “acidic gases” from sample solution. For example, in accordance with the present invention, the pH value of the fluid medium is generally reduced to less than about 7, preferably to less than about 4, for selective IC removal.

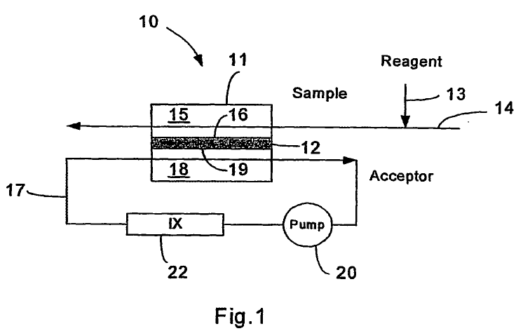

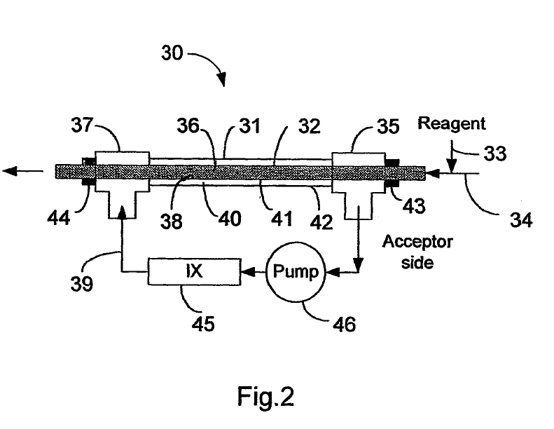

Apparatus for practicing the methods of the present invention comprises an inorganic carbon (IC) transfer unit wherein a suitable membrane separates a first compartment or fluid region from a second compartment or fluid region whereby the sample medium contacts a first (donor) side of the membrane at the same time that an acceptor medium (which may, in some embodiments, be at least a partial vacuum) contacts the opposite (acceptor) side of the membrane. As discussed below with reference to FIG. 1, in one embodiment an IC transfer unit in accordance with this invention may be of a planar design As discussed below with reference to FIG. 2, in an alternative embodiment an IC transfer unit in accordance with this invention may be of a tubular or hollow cylindrical design Other membrane/transfer unit configurations, including hybrid designs, are also considered to be within the scope of this invention.

FIG. 1 is a schematic illustration of an apparatus 10 in accordance with an embodiment of the present invention wherein the IC transfer unit 11 is of planar design. In FIG. 1, membrane element 12 of transfer unit 11 comprises a generally planar sheet or strip of the selective membrane material. An acidifying reagent 13 may or may not be added to sample fluid 14, and the sample fluid is passed into a first compartment 15 of transfer unit 11 such that the sample fluid contacts the donor face 16 of membrane element 12. A substantially carbon dioxide-free acceptor medium 17 is passed into a second (acceptor) compartment 18 of transfer unit 11 such that the acceptor medium contacts the acceptor face 19 of membrane element 12 resulting in acid gas, such as CO₂, from sample fluid 14 diffusing through membrane 12 and into acceptor medium 17, where it may be dissolved and/or ionized, e.g., into bicarbonate, if medium 17 is an aqueous fluid, or carried away as a gas if medium 17 is a gas stream. As shown in FIG. 1, an in-line pump 20, or other suitable fluid circulation system, may be used to circulate acceptor medium 17 around a closed fluid loop, which preferably may include an IC removal system 22 for removing IC from the acceptor medium coming from acceptor compartment 18 before recycling the IC-free acceptor medium to compartment 18. Also as shown in FIG. 1, in a preferred embodiment acceptor medium 17 is flowed through IC transfer unit 11 in a countercurrent direction relative to the fluid flow direction of sample fluid 14.

In a preferred embodiment of the method and apparatus illustrated in FIG. 1, membrane element 12 has a high permeability for CO₂ and a low permeability for volatile organic compounds. In another preferred embodiment of the invention as illustrated in FIG. 1, acceptor medium 17 is deionized (DI) water, and IC removal system 22 comprises an ion exchange system. In an alternative embodiment, acceptor medium 17 comprises a second portion of the sample fluid which has been made basic (for example, a pH of about 8 or higher) by the addition of alkali, if necessary. In still another embodiment, acceptor medium 17 is a substantially carbon dioxide-free gas. If the carbon dioxide-free gas is purified air, acceptor medium 17, with carbon dioxide picked up in acceptor compartment 18, may be vented downstream of compartment 18 instead of being recycled in a closed loop. In yet another embodiment, acceptor medium 17 may comprise at least a partial vacuum in acceptor compartment 18.

FIG. 2 is a schematic illustration of an apparatus 30 in accordance with an embodiment of the present invention wherein the IC transfer unit 31 is of a generally tubular design. In FIG. 2, membrane element 32 of transfer unit 31 comprises a hollow tube or conduit of the selective membrane material. An acidifying reagent 33 may be added to sample fluid 34, and the acidified or not acidified sample fluid is passed through an inlet manifold 35 into a first (donor) compartment 36 of transfer unit 31. First compartment 36 is a hollow tubular region bounded by a length of membrane element 32 extending between the IC transfer unit inlet manifold 35 and the outlet manifold 37. The sample fluid inlet conduit carrying the sample fluid to IC transfer unit 31 connects to an inlet end of first compartment 36 at inlet manifold 35. The sample fluid outlet conduit carrying the sample fluid leaving IC transfer unit 31 connects to an outlet end of first compartment 36 at outlet manifold 37. Seals or bushing elements 43 and 44, associated respectively with inlet manifold 35 and outlet manifold 37, prevent fluid leakage from the interior regions of the manifold.

Acidified or not acidified sample fluid inside compartment 36 contacts the donor face 38 of tubular membrane element 32. A substantially carbon dioxide-free or molecular acid gas-free acceptor medium 39 is passed into a second (acceptor) compartment 40 of transfer unit 31 such that the acceptor medium contacts the acceptor face 41 of the tubular membrane element 32 resulting in acid gas, such as CO₂, from sample fluid 34 diffusing through membrane 32 and into acceptor medium 39 where it may be dissolved and/or ionized, e.g., into bicarbonate, if medium 39 is an aqueous liquid, or carried away as a gas if medium 39 is a gas stream.

As seen in FIG. 2, acceptor compartment 40 is an annular region surrounding membrane element 32, the annular region being defined on the inside by acceptor face 41 of membrane element 32 and on the outside by the inner wall of a sleeve or conduit 42 of larger diameter than membrane element 32 and positioned substantially concentric relative to membrane element 32 between inlet manifold 35 and outlet manifold 37. As shown in FIG. 2, in a preferred embodiment an acceptor medium inlet conduit carrying substantially carbon dioxide-free acceptor medium to IC transfer unit 31 connects to an inlet end of acceptor compartment 40 at outlet manifold 37. Correspondingly, the acceptor medium outlet conduit carrying acceptor medium leaving IC transfer unit 31 connects to an outlet end of acceptor compartment 40 at inlet manifold 35. This configuration results in a preferred embodiment wherein acceptor medium is flowed through IC transfer unit 31 in a countercurrent direction relative to the flow of acidified sample fluid through IC transfer unit 31.

As shown in FIG. 2, an in-line pump 46, or other suitable fluid circulation system, may be used to circulate acceptor medium around a closed fluid loop, which preferably may include an IC removal system 45 for removing IC from the acceptor medium coming from acceptor compartment 40 before recycling the IC-free acceptor medium back to compartment 40. In a preferred embodiment of the method and apparatus illustrated in FIG. 2, membrane element 32 has a high permeability for CO₂ and a low permeability for volatile organic compounds. In another preferred embodiment of the invention as illustrated in FIG. 2, acceptor medium 39 is DI water, and IC removal system 45 comprises an ion exchange system. Other variations in the practice of this invention as described above for FIG. 1 can be adapted for use with the apparatus configuration of FIG. 2.

It will be understood that the apparatus illustrated in FIG. 2, with obvious minor modifications, could also be utilized to practice an alternative embodiment of this invention wherein acidified or not acidified sample fluid is passed through the outer annular-shaped compartment 40 and acceptor medium 39 is passed through the inner tubular compartment 36 of IC transfer unit 31. Of course, in this modified configuration, compartment 40 would be the sample fluid (donor) compartment and compartment 36 would be the acceptor medium compartment. Also, in this modified configuration, sample fluid would contact outer face 41 of membrane 32, whereas acceptor medium 39 would contact inner face 38 of membrane 32.

Also, while FIGS. 1 and 2 illustrate preferred countercurrent flow configurations, it will be understood that both of these embodiments of the present invention can be practiced using cocurrent flows of the sample fluid and the acceptor medium through the respective IC transfer units.

The membrane materials in accordance with this invention theoretically can be any gas-permeable materials depending on the chemical structures of the material that is to be passed through the membrane and the materials that are to be retained in the sample fluid. It is preferred to use a membrane material which has a relatively high permeation rate for the volatile compound that is to be removed from the fluid medium relative to low permeation rates for the material(s) that is(are) not to be removed from the sample fluid. The amount of volatile compound transferred from sample (donor) stream to the acceptor side, M_{acc}, is given by the following equation:
M_{aco}≈Mₛ(1−exp(−P₀tᵣₑₛ exp(−A/T))),
where:

P₀=Permeation at 25° C.

A=Activation energy

T=Temperature of the membrane

Mₛ=Initial concentration of volatile compound in the sample stream

tᵣₑₛ=Residence time of the sample stream in the IC removal module

Therefore, the relative amount of removed volatile compound, RM, is:
RM=M_{acc}/Mₛ≈1−exp(−P₀tᵣₑₛ exp(−A/T)).
Relative removal of the volatile component increases, at any given permeation rate, as the time the sample spends in the module increases and also as the membrane temperature increases. The choice of membrane material affects the sizing of the IC removal module and the selectivity of the IC removal process. These aspects of the present invention can be optimized for a particular application by routine trial-and-error and/or by computerized modeling or similar techniques.

A particularly preferred membrane material in accordance with the present invention is a DuPont Chemical Co. polymer product marketed under the trade name Teflon AF 2400. It has been found in accordance with this invention that use of Teflon AF 2400 as the membrane for the methods and apparatus of the present invention shortens the residence time required to remove the same amount of carbon dioxide by a factor of about 200 to 300 compared to membranes of comparable dimensions made of PFA or PTFE. The rate at which carbon dioxide diffuses through the fluid medium can become the limiting factor for the removal of IC in such applications.

In general, the acceptor medium on the acceptor side of the membrane can be anything that is essentially free of the molecular acid gas compound that is being removed from the sample stream. Fluid acceptor media in accordance with this invention include:
(a) Alkaline sample fluid, or other substantially carbon dioxide-free water solutions (i.e., deionized water).

This technique is specific to removal of acid gases.
(b) Carbon dioxide-free gas stream.

The gas stream can be air purified by a carbon dioxide scrubber in combination with a circulation system, e.g., a pump, or a compressed carbon-dioxide-free gas. This method is typically relatively costly, and it is specific to carbon dioxide removal.
(c) Vacuum.

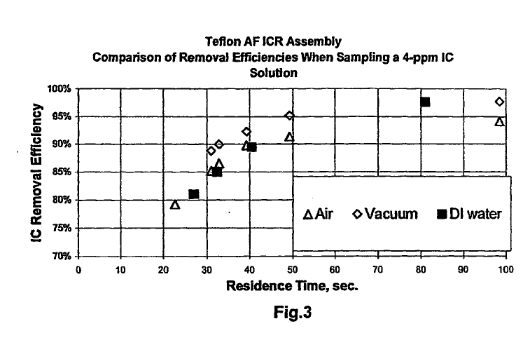

This method requires a vacuum pump and, therefore, is also relatively costly, in addition to which there can be a vacuum reliability problem. Liquid loss from the sample stream can also be a possibly significant problem with this embodiment The graph in FIG. 3 plots IC removal efficiency against residence time of the sample in the IC transfer unit for the three types of acceptor media discussed above, namely DI water, CO₂-free air, and vacuum. FIG. 3 shows that there are no significant differences in removal efficiency between the different acceptor media described above.

### EXAMPLE 1

The following tests were performed to demonstrate the practice and efficiency of this invention in the removal of a volatile electrolyte, such as carbon dioxide, from an aqueous sample at varying temperatures.

A tubular design gas transfer module similar to that illustrated in FIG. 2 was used in this example. Carbon dioxide, at a concentration of 28 ppm C in water, was passed through the inside of a tubular Teflon AF membrane. The temperature was changed by heating the acceptor stream, which was deionized water.

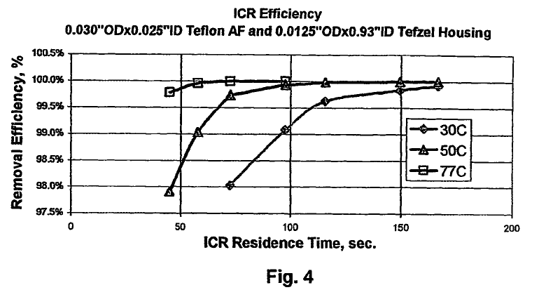

The results are illustrated in FIG. 4 which plots IC removal efficiency against residence time of the sample in the IC transfer unit at three temperatures, 30° C., 50° C. and 70° C. FIG. 4 shows that, at each temperature, essentially 100% removal of IC from the sample fluid was achieved in under three minutes (less than 180 seconds).

### EXAMPLE 2

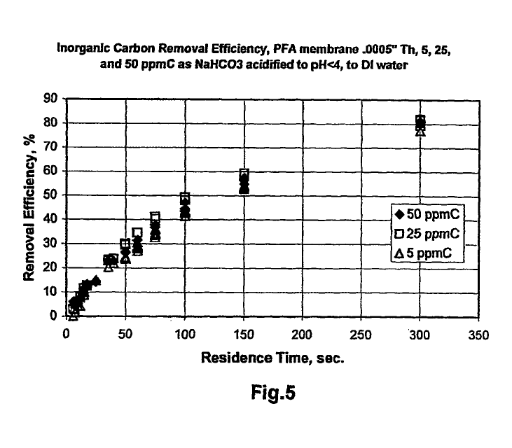

Another set of experiments was performed using an IC transfer module containing a flat or planar PFA membrane similar to the membrane configuration illustrated in FIG. 1. For this set of experiments, the sample residence time in the IC transfer module was changed by varying the sample flow rate. The results are shown in FIG. 5 which plots IC removal efficiency against residence time of the sample in the IC transfer unit at three concentrations of C and IC in the sample, 5 ppm C, 25 ppm C and 50 ppm C. FIG. 5 shows that removal efficiency for any given residence time does not vary significantly with IC concentration over a broad range.

### EXAMPLE 3

In general, a solution containing a volatile organic compound will lose a very small amount of this compound while going through the IC module of the present invention. However, the amount that is lost in this way can be minimized through the choice of the membrane material and by minimizing the sample residence time.

In this example, two different membranes were tested for IC removal in accordance with the present invention. The concentration of various volatile organic compounds in an aqueous sample stream was determined before and after the sample was passed through each of two IC transfer units according to the present invention, one such unit utilizing a Teflon AF membrane, the other utilizing a Gortex membrane. In addition, the sample stream was tested for IC (as CO₂) concentration both before and after passing through each of the two IC transfer units. A relatively short residence time of 15 seconds in the IC transfer units was used for these tests.

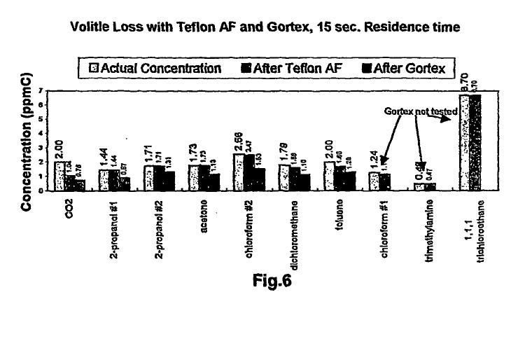

The results of this Example are shown in FIG. 6. FIG. 6 shows that the Gortex membrane achieves about 62% removal of IC, compared to about 48% for Teflon AF. However, the loss of organic compounds was more significant with the Gortex membrane in comparison to the Teflon AF membrane. When the Teflon AF membrane was used, a majority of the volatile organic compounds remained in the sample (e.g., removal of toluene was only 16%).

It will be apparent to those skilled in the art that other changes and modifications may be made in the above-described methods and apparatus for selective removal of IC from a sample fluid using selective membranes without departing from the scope of the invention herein, and it is intended that all matter contained in the above description shall be interpreted in an illustrative and not a limiting sense.

Having described the invention, what is claimed is:

1. A method for selectively removing inorganic carbon, which may include and/or be convertible to carbon dioxide, from a fluid sample, without significantly impacting the content of total organic carbon components in such sample, prior to analyzing such sample to accurately determine the concentration in the sample of very low levels of total organic carbon, said method comprising the step of bringing said fluid sample into contact with a donor face of a selectively gas-permeable membrane, said membrane having a donor face and an acceptor face and also having a relatively high permeability to carbon dioxide and a relatively low permeability to said total organic carbon components, while establishing an acceptor medium on the other side of the membrane in contact with the acceptor face of said membrane.

2. A method according to claim 1 wherein at least a measurable portion of said total organic carbon content comprises one or more volatile organic compounds.

3. A method according to claim 1 further comprising the step of acidifying said sample to convert inorganic carbon present in the sample as HCO₃⁻ and/or CO₃⁻² to carbon dioxide.

4. A method according to claim 1 comprising the step of acidifying the fluid sample to a pH of about 7 or less before it comes into contact with the membrane.

5. A method according to claim 1 comprising the step of acidifying the fluid sample to a pH of about 4 or less before it comes into contact with the membrane.

6. A method according to claim 1 wherein said acceptor medium is selected from the group consisting of (i) deionized water, (ii) a different portion of fluid sample that has been chemically treated to increase its acceptance of carbon dioxide; (iii) a gas stream having a substantially low content of carbon dioxide; and (iv) at least a partial vacuum.

7. A method according to claim 1 wherein said acceptor medium is deionized water or sample fluid which has been made alkaline, if needed, to a pH of about 8 or greater.

8. A method according to claim 1 further comprising the steps of treating said acceptor medium after it has contacted said membrane to remove or reduce the concentration of said inorganic carbon to restore the acceptor medium to a condition where it is prepared to accept more carbon dioxide, and thereafter recycling said acceptor medium to said acceptor face of said membrane.

9. A method according to claim 8 wherein said acceptor medium is treated by ion exchange.

10. A method according to claim 8 wherein said acceptor medium is treated with gas that is substantially free of carbon dioxide.

11. A method according to claim 1 wherein said membrane is a non-porous membrane.

12. A method according to claim 1 wherein said membrane is selected from the group consisting of: Teflon AF, PFA, and polyfluoropolymer.

13. A method according to claim 1 wherein said membrane is planar in shape.

14. A method according to claim 1 wherein said membrane is tubular in shape.

15. A method according to claim 1 wherein said membrane comprises a planar membrane unit, and further wherein said fluid sample is passed along one face of said membrane while the acceptor medium is established along the other face of said membrane.

16. A method according to claim 1 wherein said membrane comprises a hollow tubular membrane unit, and further wherein said fluid sample is passed through the interior of said tubular membrane unit while the acceptor medium is established in the annular region surrounding the outer wall of said tubular membrane unit.

17. A method according to claim 1 wherein said membrane comprises a hollow tubular membrane unit, and further wherein said acceptor medium is established in the interior of said tubular membrane unit while the fluid sample occupies the annular region surrounding the outer wall of said tubular membrane unit.

18. Apparatus for selectively removing inorganic carbon, which may include and/or be convertible to carbon dioxide, from a fluid sample, without significantly impacting the content of total organic carbon components in such sample, prior to analyzing such sample to accurately determine the concentration in the sample of very low levels of total organic carbon, said apparatus comprising in combination:
(a) a first fluid region for containing a donor fluid, a second region adjacent to said first region for containing or establishing an acceptor medium, said first and second regions being separated by a selectively gas-permeable membrane having a donor face in said first region and an acceptor face in said second region;
(b) a donor fluid flow control system to control flow of said donor fluid into and out of said first fluid region; and,
(c) an acceptor medium control system to control establishing said acceptor medium in said second region while said donor fluid is in contact with said donor face and for flushing said second region after the acceptor medium has accepted carbon dioxide which has diffused through said membrane.

19. Apparatus according to claim 18 wherein said membrane is planar in shape.

20. Apparatus according to claim 18 wherein said membrane is tubular in shape.

21. Apparatus according to claim 18 wherein said membrane is planar in shape, said first fluid region comprises a region adjacent to one face of said membrane, and said second fluid region comprises a region adjacent to the other face of said membrane.

22. Apparatus according to claim 18 wherein said membrane is tubular in shape, said first fluid region comprises the hollow interior of the tubular space defined by the membrane, and said second region comprises an annular region surrounding said membrane.

23. Apparatus according to claim 18 wherein said membrane is tubular in shape, said second fluid region comprises the hollow interior of the tubular space defined by the membrane, and said first region comprises an annular region surrounding said membrane.

24. Apparatus according to claim 18 wherein said membrane is a non-porous membrane.

25. Apparatus according to claim 18 wherein said membrane is a CO₂-selective membrane that has a relatively high permeability for CO₂ and a relatively low permeability for volatile organic compounds.

26. Apparatus according to claim 18 wherein said membrane is selected from the group consisting of: Teflon AF, PFA, and polyfluoropolymer.

27. Apparatus according to claim 18 further comprising an acceptor medium treatment system for treating said acceptor medium after it has contacted the acceptor face of the membrane to remove or reduce the resulting concentration of inorganic carbon to restore the acceptor medium to a condition where it is prepared to accept more carbon dioxide.

28. Apparatus according to claim 27 wherein said acceptor medium treatment system comprises an ion exchange system.

29. Apparatus according to claim 27 wherein said acceptor medium treatment system comprises a system for treating the acceptor medium with substantially carbon-dioxide-free gas.

30. Apparatus according to claim 27 further comprising an acceptor medium recirculation system for recirculating treated acceptor medium to said second region.

31. Apparatus according to claim 18 further comprising an acidification system for acidifying said donor fluid before it comes into contact with the donor face of said membrane.

32. Apparatus according to claim 18 wherein said first region contains said donor fluid and said second region contains said acceptor medium.

33. Apparatus according to claim 32 wherein said donor fluid has a pH of about 7 or less.

34. Apparatus according to claim 32 wherein said donor fluid has a pH of about 4 or less.

35. Apparatus according to claim 32 wherein said acceptor medium is selected from the group consisting of: (i) deionized water, (ii) a different portion of fluid sample that has been chemically treated to increase its acceptance of carbon dioxide; (iii) a gas stream having substantially no content of carbon dioxide; and (iv) at least a partial vacuum.

36. Apparatus according to claim 32 wherein said donor fluid is an aqueous sample containing inorganic carbon and at least a measurable portion of one or more volatile organic compounds.
